(19) United States
(12) Patent Application Publication
(10) Pub. No.: US 2018/0266554 A1
(43) Pub. Date: Sep. 20, 2018

(54) Device and Method for Arresting a Controller Cylinder of a Sequential Transmission

(71) Applicant: Bayerische Motoren Werke Aktiengesellschaft, Muenchen (DE)

(72) Inventor: Bernd MAIER, Ismaning (DE)

(21) Appl. No.: 15/986,957

(22) Filed: May 23, 2018

Related U.S. Application Data
(63) Continuation of application No. PCT/EP2016/081242, filed on Dec. 15, 2016.

(30) Foreign Application Priority Data
Feb. 8, 2016 (DE) 10 2016 201 860.4

(51) Int. Cl. F16H 63/34; F16H 63/18

(52) U.S. Cl. CPC F16H 63/34; F16H 63/18

(57) ABSTRACT

An apparatus for arresting a controller cylinder of a sequential transmission is provided. The apparatus includes an actuator which can be transitioned into an activated state by a control device to directly or indirectly engage the controller cylinder such that the controller cylinder is held in an intermediate position between two gears or between one gear and an idle position of the transmission. A related method for arresting a controller cylinder of a sequential transmission by such a device is provided, in which the controller cylinder of the transmission is rotated from a stable position into an intermediate position before the next stable position, and the actuator arrests the controller cylinder in the intermediate position.

### CROSS REFERENCE TO RELATED APPLICATIONS

This application is a continuation of PCT International Application No. PCT/EP2016/081242, filed Dec. 15, 2016, which claims priority under 35 U.S.C. § 119 from German Patent Application No. 10 2016 201 860.4, filed Feb. 8, 2016, the entire disclosures of which are herein expressly incorporated by reference.

### BACKGROUND AND SUMMARY OF THE INVENTION

The invention relates to an apparatus and to a method for locking a shifting drum of a sequential transmission.

Sequential transmissions which cannot be shifted into random gears, but rather only sequentially without skipping a gear, are used, in particular, in motorcycles and other motorized two-wheeled vehicles, trikes and quads.

The shifting of a sequential transmission can be facilitated by way of a shift assistant which makes it possible to dispense with the disconnecting of the crankshaft and the transmission input by way of a clutch for a shifting operation. Shift assistants are known which assist the upshift and downshift of the gears in this way. Comfortable gear changes are made possible in most shifting scenarios by way of a shift assistant of this type. In the case of a low load on the drive train, however, the gear change can take place without the sensor of the shift assistant being triggered which is intended to detect and indicate an impending gear change. In this case, no intervention by way of the engine controller takes place, and the shifting operation takes place without a sufficient rotational speed synchronization.

It is an object of the invention to make a reproducibly comfortable gear change possible in as many operating ranges as possible in the case of a sequential transmission.

The apparatus according to the invention for locking a shifting drum of a sequential transmission comprises an actuator which can be transferred into an activated state by a control device. In the activated state, the actuator acts directly or indirectly on the shifting drum in such a way that the shifting drum is held in an intermediate position between two gears or between a gear and a neutral position of the transmission.

Thanks to the invention, it is possible to ensure a largely load-free gear change, in which the rotational speeds of the participating gearwheels of the transmission are adapted to one another. The locking of the shifting drum in the intermediate position allows the rotational speeds to be matched in this phase in the case of a gear having been disengaged, before the next gear is then engaged. The gear change is therefore carried out as far as possible without noise and is perceived to be pleasant by the rider. In addition, the transmission is protected.

Furthermore, the assistance of an overrun upshift is made possible by way of the shifting drum lock according to the invention, since, in the case of said overrun upshift, the gradient of the rotational speed matching is restricted by the frictional power of the engine.

In order to hold the shifting drum temporarily in the intermediate position by way of the locking apparatus according to the invention, there are a plurality of possibilities. In accordance with a first alternative, the actuator of the locking apparatus engages into an outer-side recess of the shifting drum in the activated state. A suitable actuating element can thus be precisely moved in a controlled manner into the recess, in order to prevent further rotation of the shifting drum. If the actuating element is retracted again, the shifting drum can rotate further in order to complete the gear change.

In accordance with the first embodiment, the shifting drum can have a plurality of recesses which are distributed in the circumferential direction. The actuator and the recesses are then adapted to one another, in particular with regard to their shape and arrangement, in such a way that the actuator acts on at least one edge of a recess in the activated state, with the result that the shifting drum is fixed in an intermediate position as a result.

An extendable pin, in particular, is suitable as an actuating element of the actuator for the first embodiment.

In accordance with a second embodiment of the locking apparatus according to the invention, the actuator deflects a rod in the activated state, which rod is coupled to a latching lever of the transmission. In the case of said embodiment, the actuator therefore does not act directly on the shifting drum, but rather on a more readily accessible latching lever of the transmission.

The rod which is deflected in the activated state of the actuator can thus press a latching roller of the latching lever against a prong of the latching star which is customary in sequential transmissions or a similar apparatus, which latching star is coupled fixedly to the shifting drum so as to rotate with it.

In particular, a magnetic drive which as a rule has very rapid reactions is suitable as a drive for the actuator. This is of importance for reliable operation, since the shifting drum always has to be fixed in the correct position at the correct moment in the case of each assisted shifting operation.

In accordance with the preferred application of the invention, the control device of the locking apparatus is part of a controller of a shift assistant. The controller thereof can in turn be part of the engine controller or can be linked to the latter. This ensures that the actuation of the actuator can be adapted in the best possible way to the rotational speeds of the driveshaft and the output shaft of the transmission.

The invention also provides a method for locking a shifting drum of a sequential transmission with the aid of an apparatus of the above-described type. The method according to the invention comprises the following steps: rotating of the shifting drum of the transmission out of a stable position into an intermediate position in front of the next stable position, and locking of the shifting drum in the intermediate position by way of activation of the actuator.

With regard to the advantages of the method according to the invention, reference is made to the above statements with respect to the locking apparatus according to the invention.

In accordance with the method according to the invention, the actuator is to be deactivated when the rotational speed of the driveshaft coincides with the rotational speed of the output shaft of the transmission.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a perspective view of a sequential transmission by way of a diagrammatic illustration of a first embodiment of an apparatus according to the invention for locking the shifting drum of the transmission.

FIG. 2 shows a plan view of the sequential transmission from FIG. 1 without the apparatus according to the invention.

FIG. 3 shows a diagrammatic illustration of a second embodiment of an apparatus according to the invention for locking the shifting drum of a sequential transmission.

### DETAILED DESCRIPTION OF THE DRAWINGS

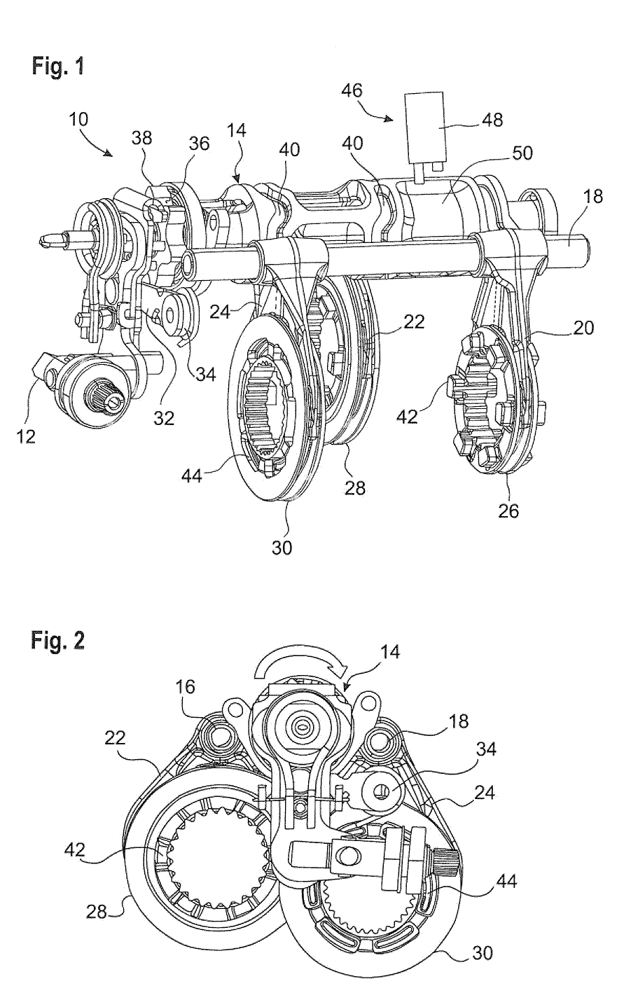

FIGS. 1 and 2 show a sequential transmission 10 by way of example, as is used in the case of motorcycles, in particular. Essential components of the sequential transmission 10 are, inter alia, a shifting axle 12, a shifting drum 14, a transmission input shaft and a transmission output shaft (driveshaft and output shaft, both not shown), and selector forks 20, 22, 24 which can be displaced on axles 16, 18 which run parallel to the transmission shafts, which selector forks 20, 22, 24 in each case hold a gearwheel pair 26, 28, 30.

In the case of every gear change, the shifting axle 12 rotates the shifting drum 14 by a defined rotary angle in a known way. In the case of six gears, the shifting drum 14 has six stable positions which are as a rule distributed uniformly over the circumference. (Neutral corresponds as a rule to a position between the first and the second gear.) This means that the shifting drum 14 has to be rotated by 60° between two gears in the case of every shifting operation; in a first rotational direction in the case of an upshift, and in the opposite direction in the case of a downshift. In the case of more or fewer gears, the number of stable positions is accordingly higher or lower, and the rotary angle is accordingly smaller or greater.

A latching lever 32 is mounted in a sprung manner and presses a latching roller 34 against the latching star (latching wheel) 36 which is connected fixedly to the shifting drum 14 so as to rotate with it. When a prong 38 of the latching star 36 has been overcome, the latching roller 34 presses the latching star 36 and therefore the shifting drum 14 into a stable position and fixes them.

Channels 40 are milled into the shifting drum 14, into which channels 40 the guide mandrels of the selector forks 22, 24, 26 engage. By way of the slotted guide which is formed in this way, one or more selector forks 22, 24, 26 are displaced on the axles 16, 18 in the case of every rotation of the shifting drum 14, and therefore the associated gearwheel pairs 26, 28, 30 are shifted axially on the transmission shafts. The lateral claws 42 of a gearwheel pair 26, 28, 30 can be moved into or out of matching receptacles 44 of an adjacent gearwheel pair 26, 28, 30 in a controlled manner as a result. Said interlocking or release of adjacent gearwheel pairs 26, 28, 30 corresponds to the actual shifting operation.

FIG. 1 symbolically shows an apparatus 46 for locking the shifting drum of the transmission in accordance with a first embodiment. The apparatus 46 has an actuator 48 which can suppress a rotation of the shifting drum 14 on request. More precisely, the actuator 48 can engage into outer-side recesses 50 of the shifting drum 14, for example, by one or more extendable pins, with the result that, in the case of (further) rotation of the shifting drum 14, an edge of the respective recess 50 butts against the actuator 48 and stops the shifting drum 14. The activator 48 and the recesses 50 are adapted to one another with regard to their shape and arrangement in such a way that the locking apparatus 46 can fix the shifting drum 14 between two stable positions. Said intermediate positions correspond to positions, in which the latching roller 34 of the latching lever 32 which is mounted in a sprung manner lies on a prong 38 of the latching star 36, which corresponds to an instable position without or in the case of an inactive locking apparatus 46. As long as the activator 48 is activated, the shifting drum 14 remains in the intermediate position and cannot be rotated in the forward or reverse direction.

The locking apparatus 46 has a control device (not shown) which decides using defined input signals when the actuator 48 is activated and deactivated. The control device can be part of a higher-order controller, in particular a controller of a shift assistant. In the following text, the method of operation of the locking apparatus 46 will be described in conjunction with a shift assistant of this type using the example of a sequential transmission 10 of a motorcycle.

The driver presses the foot gear change lever of the motorcycle upward or downward without clutch actuation, as a result of which a sensor on the foot gear change lever generates a signal which is fed to the controller. A spring is possibly prestressed during the pressing of the foot gear change lever. Via an articulated connection, the foot gear change lever rotates the shifting axle 12 which in turn rotates the shifting drum 14 if the drive train is sufficiently relieved of load. The controller of the shift assistant activates the actuator 48 in a timely manner, with the result that the shifting drum 14 can rotate only as far as the next intermediate position and is locked there. In the case of a six-gear transmission, this corresponds approximately to a 30° rotation. This limited rotation of the shifting drum 14 is sufficient firstly, in order to disengage the previously engaged gear; secondly, the rotation is not sufficient to engage the next gear.

While the shifting drum 14 is situated in the intermediate position, the engine rotational speed is adapted via the engine controller in such a way that the rotational speed of the drive and the output coincide. The actuator 48 is then deactivated, and the shifting drum 14 can rotate further as far as the next stable position, with the result that the desired gear is engaged. The delayed engagement of the gear is assisted by way of the force of the prestressed spring, with the result that the driver does not again have to actuate the foot gear change lever, in order to bring about the further rotation of the shifting drum 14.

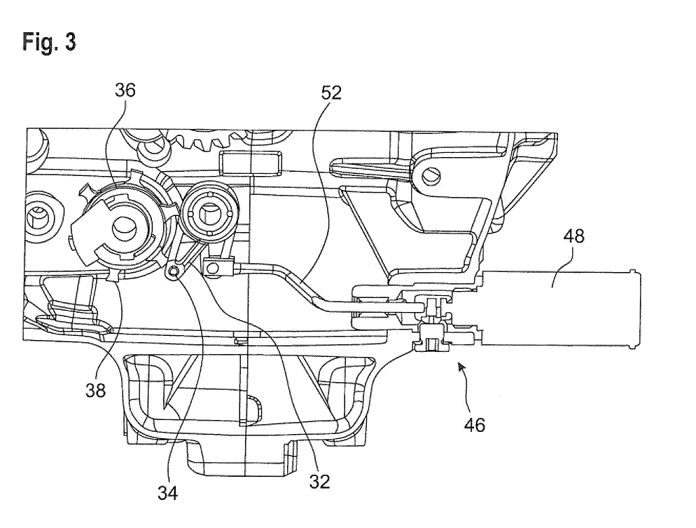

FIG. 3 shows an alternative embodiment of the locking apparatus 46. Here, a magnetic drive with rapid reactions is used as an actuator 48, which magnetic drive can deflect a rod 52. The rod 52 is coupled to the latching lever 32 of the transmission 10 in such a way that, in the case of the deflected rod 52, the latching roller 34 is pressed against the prong 38 of the latching star 36 in such a way that the shifting drum 14 which is connected fixedly to the latching star 36 so as to rotate with it is fixed in the intermediate position. Upon deactivation of the magnetic actuator 48, the rod 52 is released or is withdrawn in an active manner, with the result that the shifting drum 14 can rotate further into the next stable position.

As has already been mentioned, the function has been described using specific examples. It is readily apparent to a person skilled in the art that the locking apparatus 46 can fundamentally be used in the case of every type of sequential transmission, in principle even without a shift assistant.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF DESIGNATIONS

10 Transmission
12 Shifting axle
14 Shifting drum
16 Axle
18 Axle
20 Selector fork
22 Selector fork
24 Selector fork
26 Gearwheel pair
28 Gearwheel pair
30 Gearwheel pair
32 Latching lever
34 Latching roller
36 Latching star
38 Prong
40 Channels
42 Claws
44 Receptacles
46 Locking apparatus
48 Actuator
50 Recesses
52 Rod

What is claimed is:

1. An apparatus for locking a shifting drum of a sequential transmission, comprising:
an actuator;
a control device configured to transfer the actuator into an activated state in which the actuator acts directly or indirectly on the shifting drum to hold the shifting drum in an intermediate position between two adjacent gears in the transmission or between a gear and a neutral position of the transmission.

2. The apparatus as claimed in claim 1, wherein
the actuator is configured to engage into one of a plurality of outer-side recesses of the shifting drum in the activated state.

3. The apparatus as claimed in claim 2, wherein
the shifting drum has the plurality of outer side recesses are distributed in the circumferential direction of the shift drum, and
the actuator and the recesses have complementary shapes configured such that the actuator acts on at least one edge of one of the plurality of recesses in the activated state to fix the shifting drum in the intermediate position.

4. The apparatus as claimed in claim 3, wherein
the actuator has at least one extendable pin.

5. The apparatus as claimed in claim 1, wherein
the actuator is configured to deflect a rod coupled to a latching lever of the transmission in the activated state.

6. The apparatus as claimed in claim 5, wherein
when the actuator is in the activated state, the rod presses a latching roller of the latching lever against a prong of a latching star of the transmission.

7. The apparatus as claimed in claim 6, wherein
the actuator has a magnetic drive.

8. The apparatus as claimed in claim 3, wherein
the actuator has a magnetic drive.

9. The apparatus as claimed in claim 1, wherein
the control device is part of a controller of a shift assistant.

10. A method for locking a shifting drum of a sequential transmission having an actuator and a control device configured to transfer the actuator into an activated state, comprising the acts of:
rotating of a shifting drum of the transmission out of a stable position into an intermediate position between the stable position and the next stable position; and
activating the actuator into an activated state with the control device such that the actuator locks the shifting drum an intermediate position.

11. The method as claimed in claim 10, wherein
the actuator is deactivated when a rotational speed of a driveshaft driven by the transmission coincides with a rotational speed of an output shaft of the transmission.
